(19) United States
(12) Patent Application Publication
(10) Pub. No.: US 2012/0255627 A1
(43) Pub. Date: Oct. 11, 2012

(54) HOSE REEL ASSEMBLY HAVING LIMITED HARDWARE

(75) Inventor: PETER ARCATI, Dillsburg, PA (US)

(73) Assignee: AMES TRUE TEMPER, INC., Camp Hill, PA (US)

(21) Appl. No.: 13/082,811

(22) Filed: Apr. 8, 2011

(51) Int. Cl. B65H 75/40; F16D 1/06; B65H 75/44

(52) U.S. Cl. 137/355.27; 242/398; 403/164

(57) ABSTRACT

A hose reel that may be assembled substantially without coupling hardware is provided. That is, the hose reel uses other types of coupling devices, notably snap-fit couplings for substantially all connections. This concept requires new components, such as a rotational coupling disposed between the hose reel frame assembly and the rotating basket assembly.

### FIELD OF THE INVENTION

The present invention relates to hose reels and, more specifically to a hose reel that is assembled substantially without coupling hardware.

### BACKGROUND OF THE INVENTION

Complex devices, e.g. devices formed from a plurality of other components, are typically designed in view of their manufacturing/assembly process. That is, the device is not simply designed to perform a function, but also designed so that it may be easily assembled. Many assemblies include a plurality of “coupling hardware” such as, but not limited to, screws, nuts and bolts, pins with or without cotter pins, threaded rods (partially threaded or fully threaded), and rivets. The use of coupling hardware typically increases the time and cost of assembly.

For example, hose reels are constructs structured to rotatably support a hose. A typical hose reel includes a frame assembly, a basket assembly about which the hose is wound, a water conduit assembly, wheels, and various other components. When these components are coupled using coupling hardware, there is an increase in the manufacturing time and cost. Such coupling hardware is used, however, because there may not be an alternative. For example, one area of a hose reel that is subjected to stress is the interface between the basket assembly and the frame assembly. When the hose on the basket assembly fills with water, the hose expands, which depends upon how the hose is positioned, the hose typically applies a force to the basket assembly causing the basket assembly to deform and/or expand. This change in the basket assembly configuration causes stress on the interface between the basket assembly and the frame assembly. Such stress is exacerbated when the basket assembly is rotated. To handle such stress the hose reel components, which are typically plastic, must be supported or reinforced with metal components, typically coupling hardware and/or a bearing disposed between the frame assembly and the basket assembly. Thus, a typical interface between the frame assembly and the basket assembly requires both a bearing, the hardware for attaching the bearing to one of the assemblies, as well as coupling hardware to rotationally couple the components together.

### SUMMARY OF THE INVENTION

The purpose of the present disclosure is to provide a hose reel that may be assembled substantially without coupling hardware. This is accomplished by using other types of coupling devices, notably snap-fit couplings. While snap-fit couplings have been used in hose reels, no hose reel is assembled almost exclusively by such couplings. Moreover, the disclosed concept includes new hardware, such as a rotational coupling, that allows for the assembly substantially without coupling hardware. That is, rather than using a separate bearing, the rotational coupling provides for a unitary element that acts as both the bearing and the coupling device. It is noted that the bearing portion of the rotational coupling is made from a different material than the other elements of the frame assembly. As such the bearing portion is stronger, has a lower coefficient of friction, materials will not react and fuse together under friction due to different chemical compositions. The rotational coupling also includes snap-fit couplings thereby removing the need for coupling hardware.

### BRIEF DESCRIPTION OF THE DRAWINGS

A full understanding of the invention can be gained from the following description of the preferred embodiments when read in conjunction with the accompanying drawings in which:

FIG. 1 is an isometric view of a hose reel.

FIG. 2A-2C are assembly views of the hose reel. FIG. 2A shows the basket assembly and the side frame assemblies. FIG. 2B further shows the handle assembly. FIG. 2C further shows the base assembly.

FIG. 3A-3C show alternate cross-sectional views of closed extrusion members. FIG. 3A shows a closed extrusion member with a flat base plate. FIG. 3B shows a closed extrusion member with an angled base plate. FIG. 3C shows a closed extrusion member with an arcuate base plate.

FIG. 4 shows a bottom view of the hose reel.

FIG. 5 is a detail of the handle assembly and tray.

FIG. 6 is an isometric view of one side of the basket assembly. FIG. 6A is a detailed view of the water conduit coupling device.

FIG. 7 is an isometric view of the inlet conduit assembly.

### DESCRIPTION OF THE PREFERRED EMBODIMENTS

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other. The fixed components may, or may not, be directly coupled.

As used herein, the word “unitary” means a component is created as a single piece or unit. That is, a component that includes pieces that are created separately and then coupled together as a unit is not a “unitary” component or body.

As used herein, “coupling hardware” means coupling devices that are not unitary with another component such as, but not limited to, screws, nuts and bolts, pins with or without cotter pins, threaded rods (partially threaded or fully threaded), and rivets that are used to couple components to each other. Often, but not always, “hardware” is made of metal. “Hardware” does not include fluid couplings, such as, but not limited to, the threaded ends of hoses.

As used herein, “substantially without coupling hardware” means less than three units of coupling hardware are used.

As used herein, “without coupling hardware” means no coupling hardware is used.

As used herein, “snap-fit coupling” means a coupling device having a latch member disposed on a flexible member wherein the latch member engages a corresponding pocket or edge. Typically, the snap-fit coupling has an elongated flexible member with a latch member or surface extending generally perpendicular to, or much less than ninety degrees, to the longitudinal axis of the elongated member. The latch surface may engage an edge, such as, but not limited to, the edge of an opening in another component, or a pocket or similar feature in another component. The snap fit coupling may be “blind,” meaning the latch member is generally unaccessible once the coupling is engaged, or “open,” meaning the latch member is generally accessible so that the coupling may be released after engagement. It is hereinafter understood that, even if an edge, pocket or other surface is not specifically mentioned, each “snap-fit coupling” has such a surface for the latch member to engage. Further, as is known, there is typically an angled surface between the latch member and the distal tip of the flexible member. When the snap-fit coupling is engaged, the angled surface contacts the component that the latch surface is about to engage, causing the flexible member to flex away from the component. Once the angled surface passes the component, the flexible member returns to its original configuration while the latch surface engages the other component. It is understood that any snap-fit coupling may, and typically does, have such an angled surface.

As used herein, “temporarily coupled” means that two components are coupled in a manner that allows for the components to be easily decoupled without damaging the components.

As used herein, “correspond” indicates that two structural components are sized to engage each other with a minimum amount of friction. Thus, an opening which corresponds to a member is sized slightly larger than the member so that the member may pass through the opening with a minimum amount of friction. This definition is modified if the two components are said to fit “snugly” together. In that situation, the difference between the size of the components is even smaller whereby the amount of friction increases.

As used herein a “handle” is an element that is generally structured to be grasped by a user and not an element that is merely capable of being grasped. For example, a wheelbarrow frame assembly may have a plurality of elongated members that may be grasped, but only the handles are structured, i.e. positioned and sized, to be grasped by the user.

As used herein, a “grip” is the portion of a handle structured to be gripped by a user. A “grip” includes a portion of a handle having a sufficient, substantially straight length of handle to accommodate the width of four fingers, and may also include a textured surface on the handle and/or a padded portion of the handle. A “grip” must be distinguishable from other portions of the handle. For example, a smooth, straight broomstick is a handle without an identifiable grip because no portion of the handle is different than any other portion.

As is known, a hose reel 10, discussed below, is commonly mounted on fixed orientation wheels (i.e. the wheel assembly does not include a vertical axis similar to an office chair caster). When a basket assembly 200, discussed below, is disposed in a fixed orientation to a frame assembly 20, discussed below, the axis of rotation of the basket assembly 200 typically extends horizontally and perpendicularly to the direction of travel of the hose reel. Accordingly, as used herein, the “longitudinal axis” of the hose reel 10 extends in the direction of travel of the hose reel 10; that is, generally horizontal and perpendicular to the wheel's horizontal axis of rotation. Further, the “lateral axis” of the hose reel 10 extends generally perpendicular to the “longitudinal axis” in a generally horizontal plane.

As described below, there are several components of the hose reel that have similar corresponding components, often a mirror image component. It is understood when two components are being described, subsequent pairs of reference numbers relate to the respective components. For example, as set forth below, the first and second side frame assemblies 26, 28 each include a forward support member 40, 42. This means that the first side frame assembly 26 includes forward support member 40 and the second side frame assembly 28 includes forward support member 42.

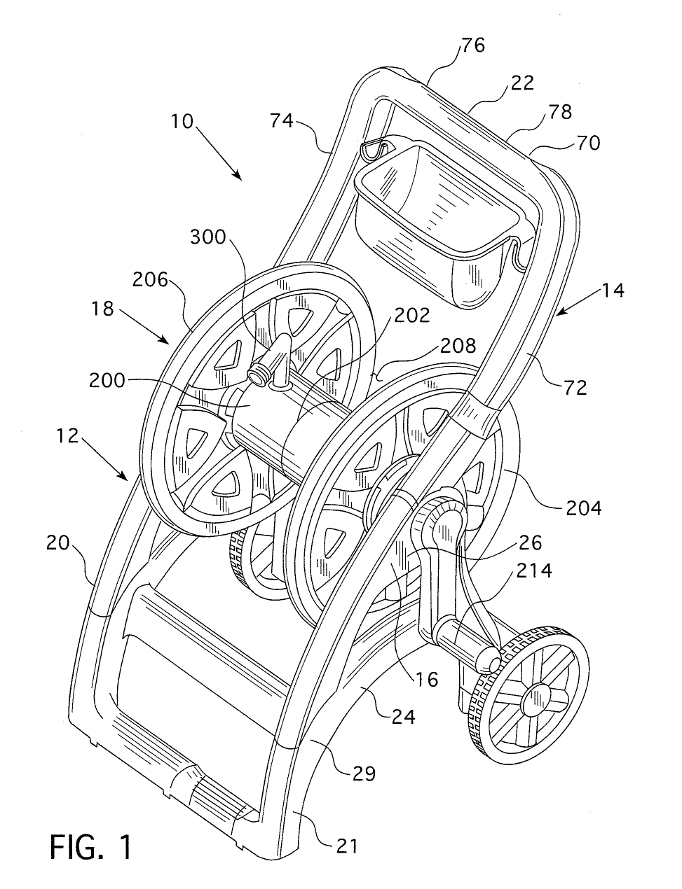

As shown in FIG. 1, a hose reel 10 includes a frame assembly 20, a rotating basket assembly 200, and a water conduit assembly 300. The hose reel 10 has a front side 12, a rear side 14, a first lateral side 16 and a second lateral side 18. Generally, the user is positioned behind the rear side 14 when moving the hose reel 10, and, to the front side 12 or one of the lateral sides 16, 18 when using the hose reel 10. Further, because the handle assembly 22 is positioned at the rear side 14, the front side 12 is typically shown when the hose reel 10 is displayed, e.g. prior to sale or in advertisements.

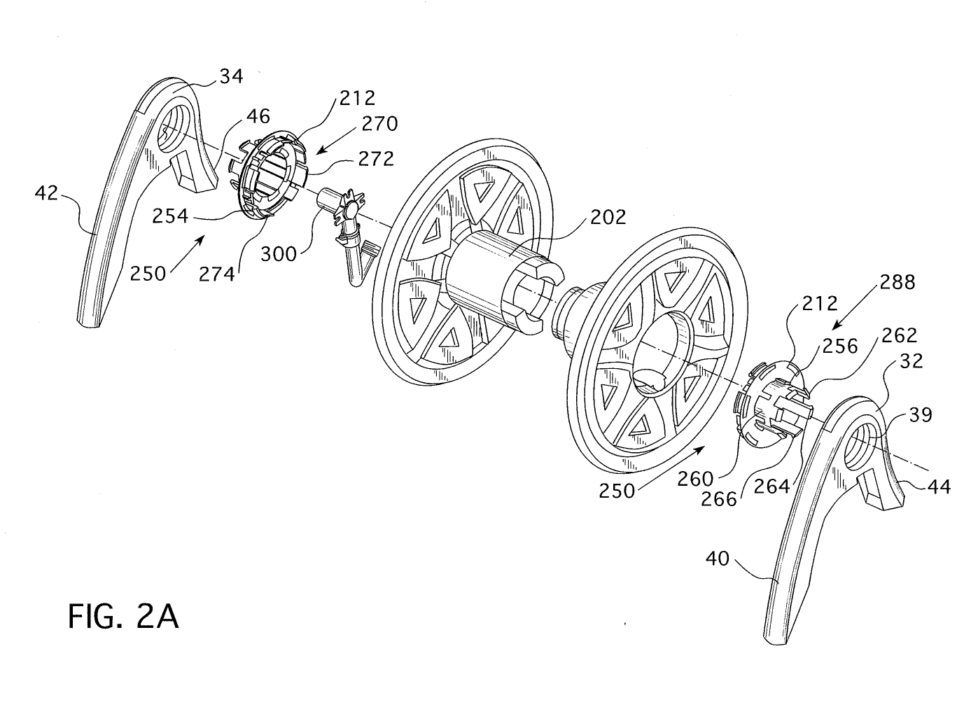

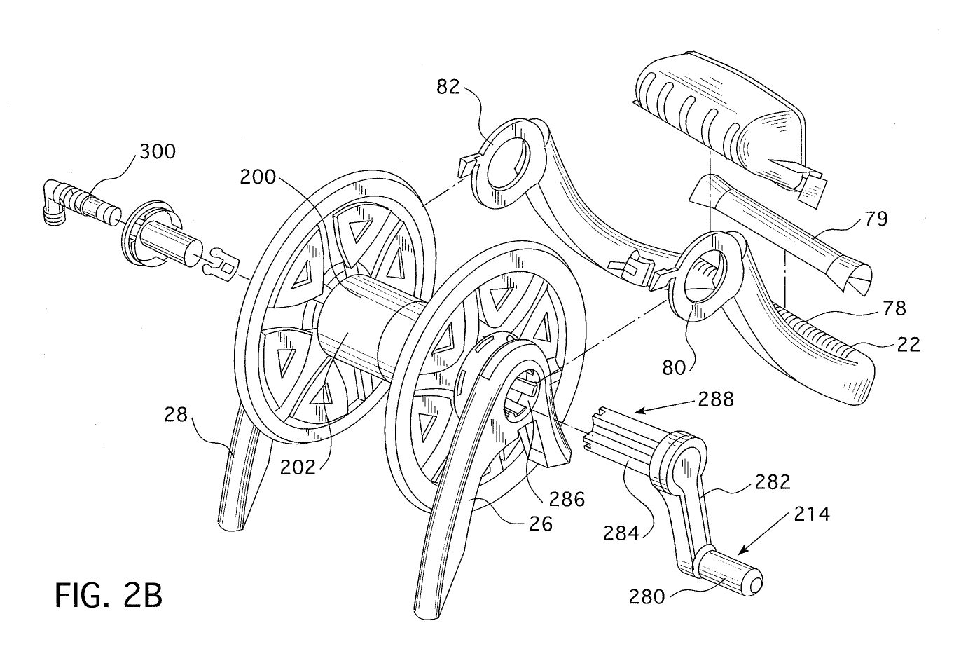

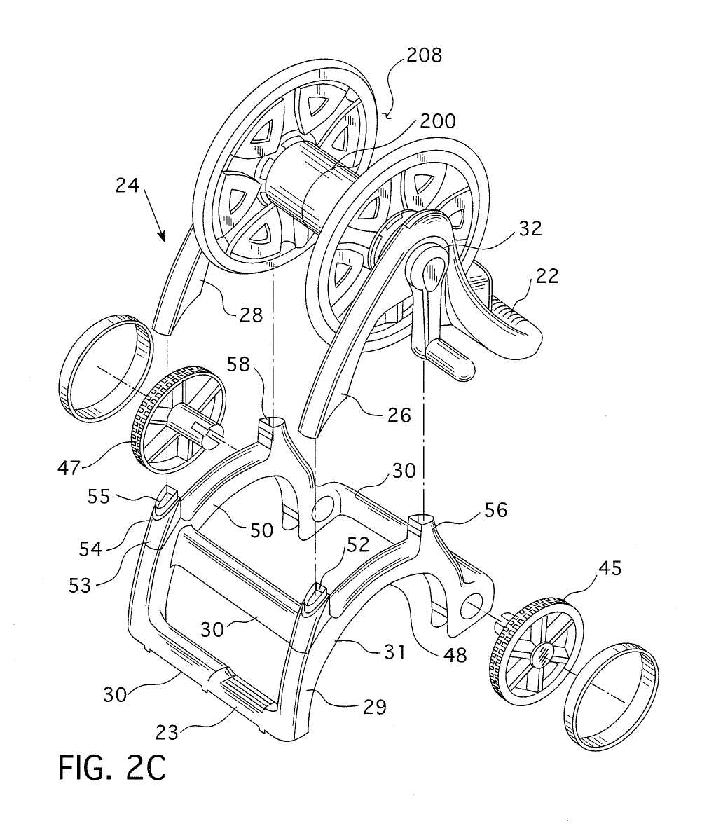

The frame assembly 20 is made from plastic components and, as detailed below, preferably from a plurality of elongated members which include at least one closed, extruded member 21. As shown in FIG. 2A-2C, the frame assembly 20 includes a handle assembly 22 and a lower frame assembly 24. The lower frame assembly 24 is structured to rotatably support the basket assembly 200. The lower frame assembly 24 includes two substantially similar side frame assemblies, a first side frame assembly 26 and a second side frame assembly 28, and, in the preferred embodiment, a base assembly 29. As used herein, the “base assembly” is that portion of the frame assembly 20 that is structured to contact the ground directly or be directly coupled to a wheel or wheel assembly. As discussed in detail below, this base assembly 29 includes frame members on both lateral sides 16, 18 of the base assembly 29 as well as on both the forward and rear sides of the base assembly 29 while still being a unitary body. The two side frame assemblies 26, 28 are maintained in a spaced relation by the basket assembly 200 and, after final assembly, by one or more elongated cross frame members 30 located on the base assembly 29. The two side frame assemblies 26, 28 each have a forward support member 40, 42 and a rear support member 44, 46. The side frame assemblies 26, 28 are shaped generally as an inverted “V.” At the vertex of each side frame assembly 26, 28 is a hub 32, 34, to which the basket assembly 200 is rotatably coupled. The side frame assemblies hubs 32, 34 each have a circular opening 36, 38 therethrough, The hub 32, 34 support members 40, 42, 44, 46, and base members 48, 50 of each lateral side of the frame assembly 20 are, generally, disposed in a plane. It is noted that the side frame assemblies 26, 28 are substantially identical. That is, the side frame assemblies 26, 28 are interchangeable. The rotational couplings 250 are rotatably disposed in the side frame assemblies hubs circular opening 36, 38. The rotational couplings 250 are made from a first material and the side frame assemblies hubs 32, 34 are made from a second material, as detailed below.

The base assembly 29 includes a first base member 48 and a second base member 50, which extend longitudinally along each lateral side of the base assembly 29, as well as one or more cross frame members 30. In a preferred embodiment, the base members 48, 50 are shaped as upwardly extending arches. On each base member 48, 50 there is a front frame coupling 52, 54, and a rear frame coupling 56, 58. Each frame coupling 52, 54, 56, 58 includes a post 53 and a lug 55. Each frame coupling 52, 54, 56, 58, and more specifically each post 53, extends generally upwardly. Each lug 55 is disposed at the distal end of the associated post 53 and each lug 55 is sized and shaped to snuggly correspond to the lower ends of the support members 40, 42, 44, 46. The side frame assemblies 26, 28 are coupled, as described below, to the upper side of the base assembly 29 to form the lower frame assembly 24. In this embodiment, the first side frame assembly 26, the second side frame assembly 28, and the base assembly 29 are each formed as a unitary body.

Further, a wheel 45, 47 (FIG. 2C) may be rotatably coupled to each lateral side of the base assembly 29. That is, a first wheel 45 is rotatably disposed at the distal, lower end of the first base member 48. Similarly, the second wheel 47 is rotatably disposed at the distal, lower end of the second base member 50. The wheel 45, 47 are coupled to the frame assembly 20 without hardware. That is, the frame assembly 20 includes laterally facing openings 49 located near the bottom of the frame assembly 20. The wheels 45, 47 each include a snap-fit coupling. That is, each wheel 45, 47 includes a plurality of elongated members 41 that extend about the wheel's axis of rotation. At the tip of each wheel elongated member 41 is an outwardly extending latch member 43. When the elongated members 41 are inserted through the laterally facing openings 49, preferably from the outer side of the frame assembly 20, the latch members 43 engage the inner side of the frame assembly 20, thereby coupling the wheels 45, 47 to the frame assembly 20 without using hardware.

The side frame assemblies 26, 28 are structured to rotatably support the basket assembly 200. That is, the basket assembly 200 includes a cylindrical barrel 202. At each end of the barrel 202 there is a radially extending flange 204, 206. The space about the barrel 202 and in between the two flanges 204, 206 define the basket 208 which is the space in which the hose reel hose (not shown) is disposed. That is, the hose reel hose is wrapped about the barrel 202. As is known, a portion of the water conduit assembly 300 extends through one axle 212 (FIG. 2A) and is structured to supply water to the hose reel hose. A basket handle, or crank 214, (FIG. 1) is fixed to the barrel 202.

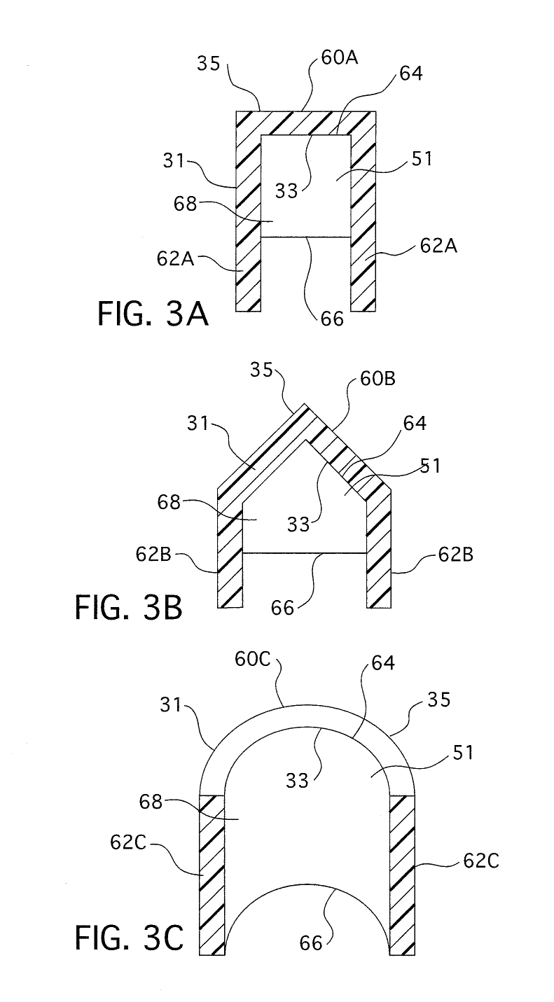

The frame assembly 20 may include various types of members, e.g. solid, hollow, closed extrusion, etc. In this disclosure, at least one frame member 30 is an elongated closed extrusion member 31, as shown in FIGS. 3A-3C. As defined above, a closed extrusion member 31 has an inner side 33 and a outer side 35. The closed extrusion member outer side 35 is generally free from mold lines, openings, couplings, etc. The closed extrusion member 31 may be a narrow channel formed from an elongated, generally flat base plate 60A having generally perpendicular, longitudinal sidewalls 62A, as shown in FIG. 3A, an elongated, angled base plate 60B with (FIG. 3B) or without (not shown) longitudinal sidewalls 62B, or in the preferred embodiment, an arcuate base portion 60C with (FIG. 3C) or without (not shown) longitudinal sidewalls 62C. That is, in an arcuate closed extrusion member 31 there is a longitudinally extending arcuate portion 60C as well as longitudinal sidewalls 62C that extend generally tangent to the ends (when viewed in cross-section) of the arcuate base portion 60C. In cross-section, this configuration resembles a capital “U.”

The at least one closed extrusion member 31 is positioned with the outer side 35 oriented to be highly visible. That is, the at least one closed extrusion member 31, or a substantial portion of the at least one closed extrusion member 31, outer side 35 faces generally forward and/or upward. Conversely, the at least one closed extrusion member 31, inner side 33 faces generally backward and/or downward. In this configuration, a user or observer will typically see the smooth outer side of the at least one closed extrusion member 31. A closed extrusion member 31 may further be supported by one or more ribs 51. The ribs 51 are disposed on the inner side 33 of a closed extrusion member 31. The ribs 51 are planar members 68 having an inner edge 64 and an outer edge 66. The rib inner edge 64 is, preferably, directly coupled to the inner side of a closed extrusion member 31 and may be formed as a unitary body therewith. Thus, the rib inner edge 64, preferably, corresponds with the shape of the closed extrusion member 31. That is, if the closed extrusion member 31 is a narrow, rectangular channel, as shown in FIG. 3A, the rib inner edge 64 is substantially linear. If the closed extrusion member 31 has an angled base plate 60B, the rib inner edge 64 has a corresponding angle. And if the closed extrusion member 31 has an arcuate base portion 60C, the rib inner edge 64 is arcuate. The rib outer edge 66 is typically either a straight edge or a curved edge. When the rib outer edge 66 is straight, it typically extends in a plane parallel to the distal ends of the closed extrusion member side walls 62A, 62B, 62C or the distal ends of the angled base plate 60B, or arcuate base portion 60C. When the rib outer edge 66 is a curved edge, the rib outer edge 66 is generally arcuate, but having a greater radius than the arcuate base portion 60C. In this configuration, the rib 51 tapers at tips of the outer edge 66. Alternatively, the rib outer edge 66 may have the same curvature as the arcuate base portion 60C, but, where the rib 51 extends over the longitudinal sidewalls 62A, the rib outer edge 66 tapers. Finally, it is noted that a rib 51 may be disposed at the very end of the closed extrusion member 31, creating a closed end, or spaced from the very end of the closed extrusion member 31, creating a pocket (not shown) defined by the rib 51 and the distal end of the closed extrusion member 31.

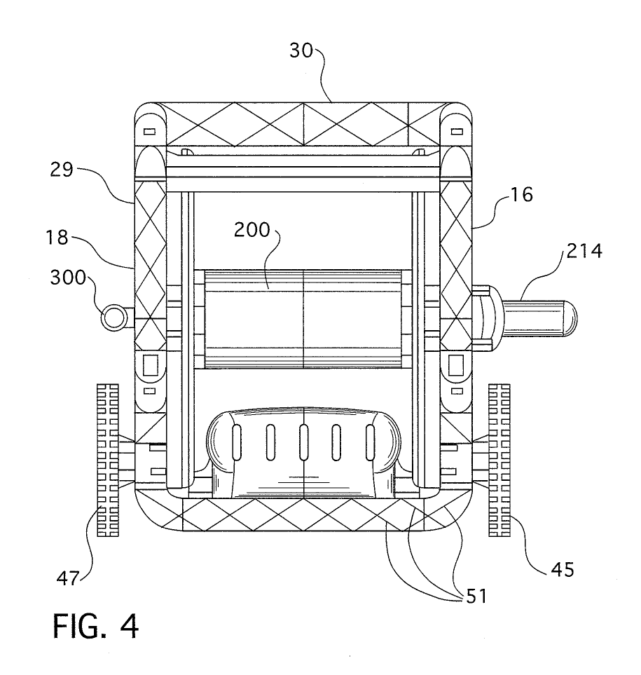

The ribs 51 may extend generally perpendicular to the longitudinal axis of the closed extrusion member 31 or may extend at an angle generally less than perpendicular to the longitudinal axis of the closed extrusion member 31. Typically, when the ribs 51 have a curved outer edge 66, the ribs 51 extend generally perpendicular to the longitudinal axis of the closed extrusion member 31. Ribs 51 in this configuration resemble the inner side of a canoe. Ribs 51 having a straight outer edge 66 typically extend at an angle generally less than perpendicular to the longitudinal axis of the closed extrusion member 31. Further, such ribs 51 typically cross over each other creating a pattern similar to “X's”, as shown in FIG. 4.

Preferably, each of the frame members forming the side frame assemblies 26, 28, and the base assembly 29 are closed extrusion members 31. That is, each support member, 40, 42, 44, 46, and each base member 48, 50 is elongated and has a lateral width, i.e. a width normal to the plane of the side frame assemblies 26, 28. The support members 40, 42, 44, 46 each descend from the associated hub 32, 34 with the forward support members 40, 42 extending toward the hose reel front side 12 and the rear support members 44, 46 extending toward the hose reel rear side 14. The distal ends of each support member, 40, 42, 44, 46 have a rib 51 spaced therefrom. That is, each distal end of each support member, 40, 42, 44, 46 forms a pocket (not shown).

As noted above, base members 48, 50 may be upwardly arched so that, when the side frame assemblies 26, 28 are coupled thereto, the two lateral sides of the frame assembly 20 generally resemble a capital “A” with the hub 32, 34 at the vertex of the support members, 40, 42, 44, 46. In this configuration, a user, and more specifically a user's eyes, will typically be disposed above the side frame assemblies 26, 28 and the base assembly 29. Thus, to reduce the chance of the user seeing the closed extrusion member inner side 33, the closed extrusion members inner sides 33 face generally downwardly. It is noted that, at the back end of the arched base members 48, 50, the closed extrusion members inner sides 33 face forwardly and, as such, could be seen by a user standing directly in front of the hose reel 10. Typically, however, the other elements of the side frame assemblies 26, 28, notably the forward support member 40, 42, will block the user's view of the forward end of the arched base members 48, 50. Only when a user is standing to one side of the hose reel 10 will the user be able to see some small portion of the arched base member closed extrusion member inner side 33. This is noted as the disclosed concept does not require that the entire closed extrusion member inner side 33 face backwardly and/or downwardly, but rather that a substantial portion of each closed extrusion member 31 face backwardly and/or downwardly.

Further, the base assembly cross frame members 30 may also be closed extrusion members 31. The cross frame members 30 are, preferably, arcuate closed extrusion members 31 having longitudinal sidewalls. The closed extrusion member cross frame members 30 may have ribs 51 disposed on the inner side. The closed extrusion member cross frame members 30 face substantially downwardly. In this configuration, a user cannot typically see the inner side of the closed extrusion member cross frame members 30. It is noted that, while the closed extrusion member outer side 35 is typically smooth, the closed extrusion member cross frame member 30 disposed at the front side 12 of the hose reel 10 may include a textured step 23. The textured step 23 is disposed on the same lateral side as the barrel crank 214. In operation, the user may stand on the textured step 23 while using the crank 214.

As noted above, each hub 32, 34, and more specifically each hub opening 36, 38 is structured to rotatably support the basket assembly 200. That is the basket assembly 200 includes a cylindrical barrel 202. At each end of the barrel 202 there is a radially extending flange 204, 206. The space about the barrel 202 and in between the two flanges 204, 206 define the basket 208 which is the space in which the hose reel hose (not shown) is disposed. That is, the hose reel hose is wrapped about the barrel 202. The basket assembly 200 further includes a bifurcated axle having two portions 210, 212. That is, at each end of the barrel 202 there is an axially extending axle 210, 212 wherein the axles 210, 212 are substantially aligned about a common axis, thereby defining a single axle.

The axles 210, 212, preferably, are hollow cylinders having a radius that is less than the radius of the barrel 202. As is known, a portion of the water conduit assembly 300 extends through one axle 212 and is structured to supply water to the hose reel hose. The basket crank 214 (FIG. 1) is fixed to the barrel 202. Preferably, the axles 210, 212 have a sufficient length so as to extend through, but not generally beyond, the hubs 32, 34. Further, the hub openings 36, 38, preferably, do not have a radius that is significantly larger than the radius of the axles 210, 212.

That is, the axles 210 212 are, preferably, rotational couplings 250 as shown in FIG. 2A. A rotational coupling 250 is structured to act as both a coupling device and a bearing. The rotational coupling 250 preferably includes a body 252 having an inner cylindrical portion 254 and an outer cylindrical portion 256. The inner cylindrical portion 254 and the outer cylindrical portion 256 are hollow. The outer cylindrical portion 256 includes a bearing surface 260 and a coupling device 262 that is preferably a snap-fit coupling device. The outer cylindrical portion coupling device 262 preferably includes a plurality of axially extending, flexible, elongated members 264 having a generally perpendicular latch member 266 extending therefrom. The outer cylindrical portion coupling device latch members 266 are structured to engage the edge created by the side frame assemblies hub circular openings 36, 38. More preferably, the side frame assemblies hub circular openings 36, 38 include one or more inwardly extending interior ridges 39 that the outer cylindrical portion coupling device latch members 266 may engage. In this configuration, the outer cylindrical portion coupling device latch members 266 do not extend beyond the side frame assemblies hubs 32, 34 and have a pleasing appearance.

The inner cylindrical portion 254 is also structured to be a coupling device 270 and is preferably a snap-fit coupling device. That is, the inner cylindrical portion coupling device 270 also may have a plurality of axially extending, flexible, members 272 having a generally perpendicular latch member 274 extending therefrom. The inner cylindrical portion coupling device coupling device 270 is structured to engage the basket assembly barrel 202 and/or the two flanges 204, 206. That is, the barrel 202, and/or the two flanges 204, 206, have a circular opening centered about the axis of rotation. Put another way, the barrel 202 may be hollow with open ends disposed at the flanges 204, 206. The inner surface of the barrel 202, and/or the two flanges 204, 206 may have openings or pockets 276 therein for the inner cylindrical portion coupling device coupling device 270 to engage. Finally, it is noted that the inner cylindrical portion 254 has a greater diameter than the outer cylindrical portion 256. Thus, the inner cylindrical portion 254 includes a torus shaped base 278 with the inner cylindrical portion flexible, elongated members 272 axially extending from the perimeter thereof.

As noted above, the rotational coupling 250 is made from a first material and the hub 32, 34, in which the rotational coupling 250 is rotatably disposed, is made from a second material. The first and second materials are both thermoplastics, but the rotational coupling 250 is made from a material that is at least 2 times as strong as the second material. Further, the first material has a coefficient of friction that is lower than the second material. For example, if the first material is Polyoxymethylene, the first material has a yield strength of 9,500 psi and a coefficient of friction of 0.2 to 3.5. Thus, the second material could be Polyethylene having a yield strength of 4,650 psi and coefficient of friction of 0.05 to 0.25. Alternatively, the second material could be Polypropylene having a yield strength of 3,100 psi and coefficient of friction of 0.1 to 0.3.

The following table indicates the various materials that satisfy the requirements set forth above.

| First materials | Second materials |
|---|---|
| Polyolefins such as, but not | Acetal such as, but not limited to |
| limited to, Polyethylene or | Polyoxymethylene |
| Polypropylene, | Polyamide like Nylon |
| | Styrenic such as, but not limited to, |
| | Acrylonitrile butadiene styrene (ABS) |

The rotational coupling 250 may also be used as a fixed orientation coupling for the basket crank 214. That is, the basket crank 214 (FIG. 2B) includes a grip 280, a crank arm 282, and a mounting lug 284. The crank arm 282 is elongated and the grip 280 and the mounting lug 284 extend perpendicular to the longitudinal axis thereof. The grip 280 and the mounting lug 284 extend in generally aligned, but opposite directions from the crank arm 282. The mounting lug 284 has a non-circular cross-sectional shape. As noted above, the outer cylindrical portion 256 is hollow and, as such, has an inner surface 286. The mounting lug 284 and the outer cylindrical portion inner surface 286 have a corresponding, non-circular shape. Thus, when the mounting lug 284 is inserted into the outer cylindrical portion 256, the two components are maintained in a fixed relationship. Moreover, the mounting lug 284 may include one or more snap-fit couplings 288. That is, the mounting lug 284 may be elongated and structured to flex at the distal end. A latch member (not shown), e.g. an extension that is generally perpendicular to the rotational axis of the mounting lug 284, may be disposed at the mounting lug 284 distal end. The rotational coupling 250 may have a pocket or an opening (not shown) structured to be engaged by the mounting lug 284 latch member. Typically, this snap-fit coupling 288 is enclosed by the barrel 202. Thus, the mounting lug 284 cannot rotate in the outer cylindrical portion 256 due to the non-circular shape and the connection, and the basket crank 214 remains in a fixed relation to the rotational coupling 250. Further, as the rotational coupling 250 is fixed, or temporarily fixed, to the barrel 202, the basket crank 214 is in a fixed relationship with the barrel 202. As such, rotation of the basket crank 214 causes the barrel 202 to rotate.

As shown in FIG. 3, a first annular coupling 90 is disposed at the first arm distal end 80. A second annular coupling 92 is disposed at the second arm distal end 82. Each annular coupling 90, 92 is, preferably, a substantially planar body 94, 96 which define a substantially circular opening 98, 100. Each circular opening 98, 100 is sized to be disposed about the axles 210, 212. Preferably, the outer perimeter of each annular coupling body 94, 96 is substantially circular as well. Each annular coupling 90, 92 is, preferably, formed from a foamed plastic. Foamed plastic tends to have a less pleasing appearance; this, however, is not an issue for the disclosed annular couplings 90, 92 as the annular couplings 90, 92 are disposed within the two side frame assemblies 26, 28.

That is, as shown in FIG. 2A, the first side frame assembly 26 includes a first slot 27. The first slot 27 extends generally parallel to, or within, the plane of the first side frame assembly 26. The first slot 27 is sized to allow the first annular coupling 90 to pass therethrough. Similarly, the second side frame assembly 28 includes a second slot 25. The second slot 25 extends generally parallel to, or within, the plane of the second side frame assembly 28. The second slot 25 is sized to allow the second annular coupling 92 to pass therethrough. The first slot 27 is disposed on the first hub 32. The plane of the first slot 27 is generally perpendicular to the axis of the first circular opening 36. The second slot 25 is disposed on the second hub 34. The plane of the second slot 25 is generally perpendicular to the axis of the second circular opening 38.

The handle assembly 22 is rotatably coupled to the lower frame assembly 24 as follows. The first annular coupling 90 is passed through the first side frame assembly first slot 27. The second annular coupling 92 is passed through the second side frame assembly second slot 25. Each annular coupling opening 98, 100 is substantially aligned with the adjacent hub opening 36, 38 so as to form a passage 110, 112 through each side frame assembly 26, 28. The basket assembly 200 is then positioned between the two side frame assemblies 26, 28 with each axle 210, 212 extending through one passage 110, 112. It is noted that the annular coupling openings 98, 100 are sized to allow the axles 210, 212 to rotate freely therein. Thus, the basket assembly 200 is free to rotate about its axis. Moreover, in this configuration the first and second annular couplings 90, 92 are disposed about said axis of rotation. As this is the location where the handle assembly 22 is coupled to the other portion of the frame assembly 20, and as this location is not offset from the basket assembly 200 (which, during use, is typically the heaviest component of the hose reel 10), the amount of stress, including torque, that the handle assembly 22 is subjected to is reduced compared to hose reels having an offset handle. It is further noted that the foamed plastic annular couplings 90, 92 are disposed within the side frame assemblies 26, 28 and, as such, are substantially not visible to the user.

In this configuration, the handle assembly 22 may move between an upper first position (FIG. 1) and a lower second position (FIG. 4). Generally, the handle assembly 22 is placed in the upper position when the user is moving the hose reel 10 from one location to another. That is, a user applies a slight downward pressure, or horizontal pressure, to the handle member 76 thereby causing the hose reel 10 to rotate about the wheels 45, 47 and lifting the lower ends of the forward support members 40, 42 off the ground.

To assemble the hose reel 10, the basket assembly 200 is coupled to the two side frame assemblies 26, 28. That is, first the rotational couplings 250 are coupled to the barrel 202 as described above, The rotational couplings 250 act as the basket assembly axle 210, 212. The first annular coupling 90 is passed through the first side frame assembly first slot 27. The second annular coupling 92 is passed through the second side frame assembly second slot 25. Thus, the annular couplings 90, 92 are aligned with the hub opening 36, 38 so as to form a passage 110, 112 through each side frame assembly 26, 28. The side frame assemblies 26, 28 are positioned on either side of the basket assembly 200. The outer cylindrical portion 256 of each rotational coupling 250 is passed through the associated hub opening 36, 38, as well as through the annular couplings 90, 92 aligned therewith. The outer cylindrical portion coupling device 262 engages the frame assembly 20 thereby rotationally coupling the basket assembly 200 with the two side frame assemblies 26, 28.

The two side frame assemblies 26, 28 are then coupled to the base assembly 29 at the frame couplings 52, 54, 56, 58. That is, the pockets located at the distal ends of each support member 40, 42, 44, 46 correspond to the lugs 55 and, more specifically, the lugs 55 snugly correspond to the pockets. Preferably, the posts 53 have an outer surface with substantially the same dimensions as the support member 40, 42, 44, 46 coupled thereto. In this configuration, there is an essentially seamless transition between the outer side 35 of each support member 40, 42, 44, 46 and the associated coupling 52, 54, 56, 58. Further, in this configuration, the base assembly 29, which, as noted above, is preferably a unitary body, does not have to be spread, or in any other way be significantly deformed in order to couple the basket assembly 200 to the base assembly 29.

The reason the base assembly 29 does not have to be deformed, e.g. spread, is because the basket assembly 200 is not directly coupled thereto. Another feature of this configuration is that the basket assembly 200 axis of rotation does not pass through the base assembly 29. More specifically, when the basket assembly 200 axis of rotation extends generally horizontally, the basket assembly 200 axis of rotation does not pass through the base assembly 29. That is, even if one were to configure a hose reel 10 so that the basket assembly 200 was not directly coupled to a base assembly 29, e.g. by having a basket assembly 200 that is coupled to a bearing which is coupled to the base assembly 29, a unitary body base assembly 29 would still be spread apart in order to position the basket assembly 200 within the base assembly 29. In this embodiment, the base assembly 29 is not deformed because the basket assembly 200 is not disposed within the space defined by the base assembly 29. This may be conveniently expressed by noting that the axis of rotation of the basket assembly 200 does not pass through the base assembly 29.

The frame assembly handle assembly 22 also includes closed extrusion members 31. As shown in FIG. 2B, the handle assembly 22 includes a generally U-shaped handle assembly body 70 with an elongated, first arm 72, an elongated second arm 74, and a handle member 76. That is, the handle assembly body 70 has two tines, i.e. the arms 72, 74, and a bight, i.e. the handle member 76. The handle member 76 may include a textured surface defining a grip 78. Each arm 72, 74 has a distal end 80, 82 spaced from the handle member 76. Similar to the support members, 40, 42, 44, 46, the handle assembly arms 72, 74 are preferably closed extrusion members 31. Each handle assembly arm 72, 74 is rotatably coupled to one of the side frame assemblies 26, 28, but may be temporarily fixed in at least one of an upper or lower position.

That is, the handle assembly 22 may move between an upper first position (FIG. 1) and a lower second position (FIG. 2C). Generally, the handle assembly 22 is placed in the upper position when the user is moving the hose reel 10 from one location to another. When the handle assembly 22 is temporarily locked in this position, a user applies a slight downward pressure, or backward horizontal pressure, to the handle member 76 thereby causing the hose reel 10 to rotate about the wheels 45, 47 and lifting the forward side of the base assembly 29 off the ground. The hose reel 10 may then be rolled from one location to another.

When the handle assembly 22 moves between the first and second positions, the first and second arms 72, 74 also move between an upper first position and a lower second position. It is noted that, unlike the prior art, wherein it is known to move the handle to the front of the hose reel 10 in the lower position, in this embodiment when the first and second arms 72, 74 are in the first position, the handle assembly body 70 extends toward the lower frame assembly 24 rear side 14, and when the first and second arms 72, 74 are in the second position, said handle assembly body 70 extends toward said lower frame assembly 24 rear side 14 as well.

As noted above, the handle assembly arms 72, 74 are preferably closed extrusion members 31. The handle assembly arms 72, 74 are positioned with the inner side 33 of the closed extrusion members 31 facing generally backwardly when in the first, upper position, and substantially downwardly when in the second, lower position. As before, the handle assembly arms 72, 74 may be any embodiment of a closed extrusion member 31, as discussed above, but are preferably arcuate closed extrusion member 31 having tangential sidewalls. The handle assembly arms 72, 74 preferably include ribs 51 having a straight outer edge 66 extending at an angle generally less than perpendicular to the longitudinal axis of the closed extrusion member 31. That is, the handle assembly arms 72, 74 preferably include ribs 51 which cross over each other creating a pattern similar to “X's”, as shown in FIG. 4. In this configuration, the user cannot, typically, see the inner side of the closed extrusion member handle assembly arms 72, 74 when the handle assembly 22 is in the second, lower position. When the handle assembly 22 is in the first position and the user is behind the hose reel 10, the user can, typically, see the inner side of the handle assembly arms 72, 74. When the hose reel 10 is used, however, the user typically moves to the front side of the hose reel 10, where the hose is located. When the user is in front of the hose reel 10, or even to the lateral sides of the hose reel 10, the user cannot see the inner side of the handle assembly arms 72, 74. Accordingly, when the handle assembly 22 is in the first position and the closed extrusion member handle assembly arms 72, 74 face generally backwards, the closed extrusion member handle assembly arms 72, 74 are positioned with the outer sides oriented to be highly visible.

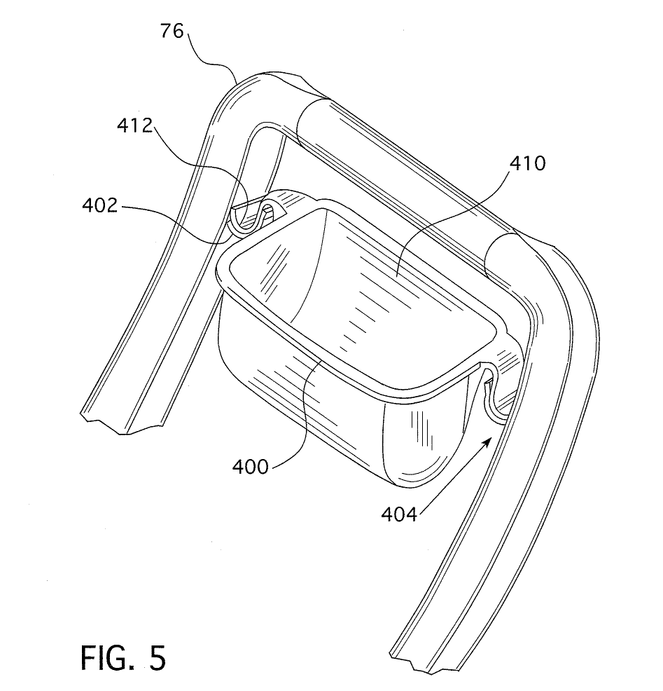

The handle member 76 may also be a closed extrusion member 31, but more preferably is formed of a series of exposed, closely spaced, parallel ribs 51, thereby forming the grip 78. A shell 79, e.g. a semicircular tube, may be disposed over a portion of the exposed ribs 51 forming the grip 78. Further, as shown in FIG. 5, the upper portion of the handle member 76 may include an accessory tray 400. The accessory tray 400 is also coupled to the frame assembly 20 without fasteners. That is, the handle assembly 22 includes at least one flexible extension 402 forming an open sided pocket 404. An “open sided pocket,” as used herein, is an extension or tab that is shaped to form a partially enclosed space having an open top, i.e. a gap between the distal end of the extension and another surface. Further, the “open sided pocket,” as used herein, has a length at the bottom of the pocket that is greater than the gap at the top. As shown, the extension forming the open sided pocket 404 is curved, but this is not required. It is noted that, in the absence of a tray 400, the curved shape may be used to support a hose as well. In this configuration, the extension must be flexed when a corresponding shape is inserted into the pocket via the gap. The frame assembly accessory tray 400 having a body 410 and at least one flexible extension 412 shaped to correspond to, and fit snugly within, the handle assembly at least one flexible extension open sided pocket 404.

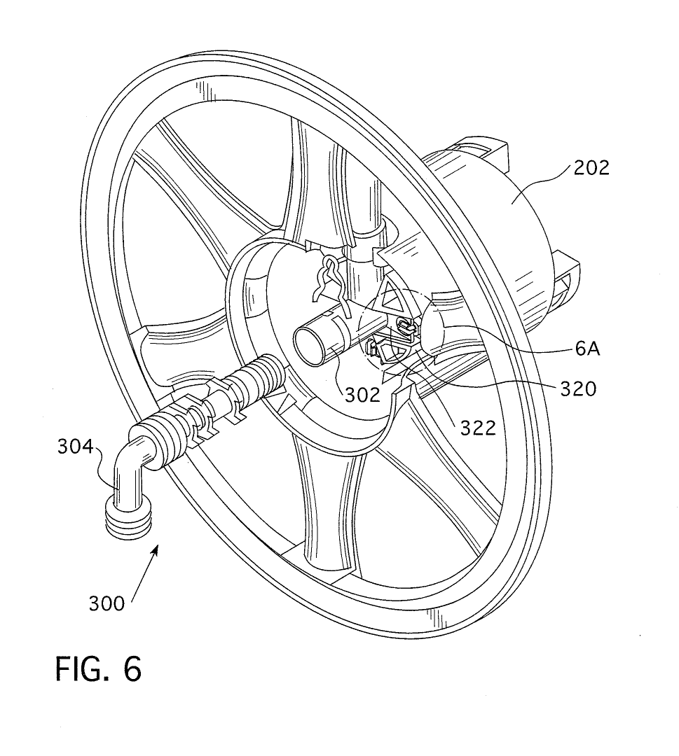

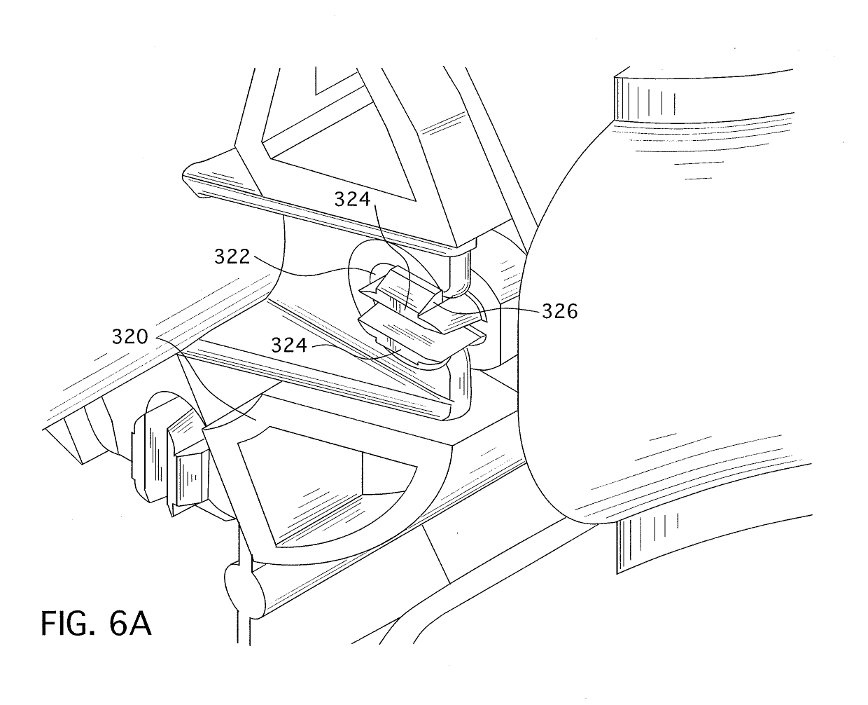

The water conduit assembly 300, shown in FIG. 6, includes a basket conduit assembly 302 and an inlet conduit assembly 304. The water conduit assembly 300 is also coupled to the basket assembly 200 and/or the frame assembly 20 without hardware. The basket conduit assembly 302 and an inlet conduit assembly 304 are detailed in co-pending application 288903-00459-1-1, which is incorporated by reference. That application details how the inlet conduit assembly 304 is coupled to the basket conduit assembly 302 using a clip assembly (not shown). The clip assembly does not utilize hardware. It is further noted that the basket conduit assembly 302 may be installed without hardware. Further, the water conduit assembly 300 conduits are, preferably, made from aluminum. Aluminum conduits 302, 304 allow for the light weight and lower cost of plastic components, but are more durable, similar to steel components.

That is, within the hollow barrel 202 there is a water conduit mount 320, as shown in FIG. 6. The water conduit mount 320 includes a plate 322 extending generally perpendicular to the barrel axis of rotation. A plurality of flexible members 324 extend outwardly and generally perpendicular to the surface of the water conduit mounting plate 322. That is, the water conduit mount flexible members 324 extend generally parallel to the barrel axis of rotation. The water conduit mount flexible members 324 are, preferably, snap-fit couplings having a generally perpendicular latch member 326, as shown in FIG. 6A. As shown, the water conduit mount flexible members 324 are, preferably, disposed in pairs.

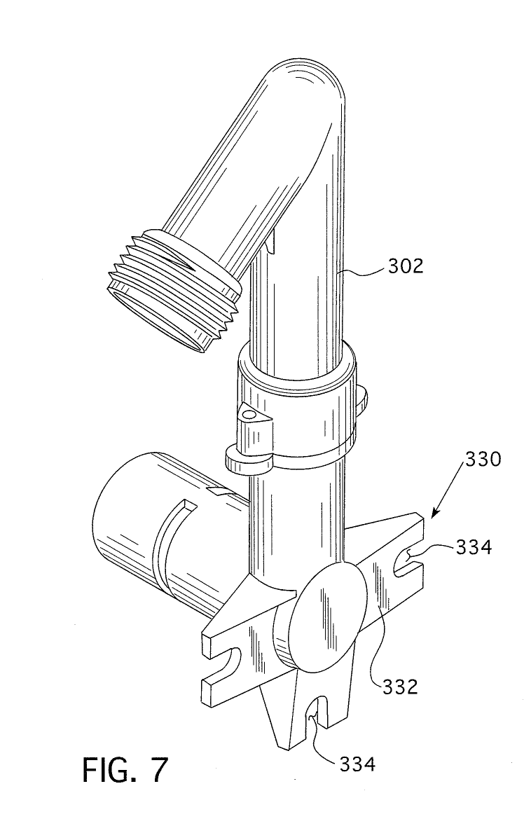

The basket conduit assembly 302, show in detail in FIG. 7, includes a plurality of mounting sockets 330. The mounting sockets 330 are plates 332 having openings 334 therein. The mounting socket plates 332 extend generally perpendicular to the barrel axis of rotation. The mounting sockets 330 are positioned to align with the water conduit mount flexible members 324. Thus, when the basket conduit assembly 302 is moved axially toward the barrel 202, the mounting sockets 330 engage the water conduit mount flexible members 324, the water conduit mount flexible members 324 engage the mounting sockets 330 in a snap-fit manner, thereby coupling the basket conduit assembly 302 to the barrel 202 without hardware. As noted above, the coupling of the inlet conduit assembly 304 to the basket conduit assembly 302 using a clip assembly is detailed in co-pending application 288903-00459-1-1.

Based on the above, the hose reel 10 is assembled substantially without coupling hardware. That is, the major components of the hose reel 10 include the base assembly 29, the first side frame assembly 26, the second side frame assembly 28, the handle assembly 24, the at least one wheel 45, the basket assembly 200, and the water conduit assembly 300. These components are coupled to each other substantially without coupling hardware and substantially by snap-fit couplings.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A rotational coupling for a hose reel, said hose reel having a frame assembly structured to rotatably support a basket assembly, said frame assembly made from a second material and having two aligned couplings, said basket assembly structured to be disposed between said aligned couplings, said rotational coupling comprising:
a body having an inner cylindrical portion and an outer cylindrical portion;
said body being a first material;
said inner cylindrical portion being a second material; and
said first material being [stronger] than said second material.

2. The rotational coupling of claim 1 wherein said inner cylindrical portion and said outer cylindrical portion are each hollow.

3. The rotational coupling of claim 2 wherein:
said inner cylindrical portion is structured to be a coupling device; and
said outer cylindrical portion having a bearing surface and a coupling device.

4. The rotational coupling of claim 3 wherein:
said inner cylindrical portion includes a torus shaped base and a plurality of axially extending, flexible members, said flexible members having a latching member thereon; and
said outer cylindrical portion coupling device including a plurality of axially extending, flexible members, said flexible members having a latching member thereon.

5. The rotational coupling of claim 4 wherein:
said first material is selected from the group comprising: Polyolefins; and
said second material is selected from the group comprising: Polyamides, Styrenics or Acetals.

6. A hose reel comprising:
a basket assembly, said basket assembly having a cylindrical barrel with an axis of rotation, said basket assembly structured to be rotatably coupled to a frame assembly and to rotate about said axis;
a frame assembly having two hubs each with an opening, said hub openings being aligned, said frame assembly openings structured to rotatably support said basket assembly;
at least one rotational coupling disposed between said basket assembly and said frame assembly, said at least one rotational coupling rotatably coupled to at least one frame assembly opening, said rotational coupling including a body having an inner cylindrical portion and an outer cylindrical portion;
said outer cylindrical portion being a first material;
said inner cylindrical portion being a second material; and
said first material being [stronger] than said second material.

7. The hose reel of claim 6 wherein said inner cylindrical portion and said outer cylindrical portion are each hollow.

8. The hose reel of claim 7 wherein:
said inner cylindrical portion is structured to be a coupling device; and
said outer cylindrical portion having a bearing surface and a coupling device.

9. The hose reel of claim 8 wherein:
said inner cylindrical portion includes a torus shaped base and a plurality of axially extending, flexible members, said flexible members having a latching member thereon; and
said outer cylindrical portion coupling device including a plurality of axially extending, flexible members, said flexible members having a latching member thereon.

10. The hose reel of claim 9 wherein:
said first material is selected from the group, comprising: Polyolefins; and
said second material is selected from the group comprising: Polyamides, Styrenics or Acetals.

11. The hose reel of claim 7 wherein:
said outer cylindrical portion inner surface has a non-circular cross-sectional shape;
said basket assembly includes a crank having a grip, a crank arm, and a mounting lug; and
said mounting lug having a non-circular cross-sectional shape corresponding to the shape of said outer cylindrical portion inner surface, whereby said mounting lug is structured to be disposed in said outer cylindrical portion and thereby be fixed thereto.

12. A hose reel comprising:
a frame assembly having a lower frame assembly, a first side frame assembly, a second side frame assembly, a handle assembly and at least one wheel;
a basket assembly, said basket assembly having a cylindrical barrel with an axis of rotation, said basket assembly structured to be rotatably coupled to a frame assembly and to rotate about said axis;
a water conduit assembly structured to be coupled to said basket assembly; and
wherein said lower frame assembly, said first side frame assembly, said second side frame assembly, said handle assembly, said at least one wheel, said basket assembly, and said water conduit assembly are coupled together by non-hardware couplings.

13. The hose reel of claim 12 wherein:
said base assembly, said first side frame assembly, said second side frame assembly, said handle assembly, said at least one wheel, said basket assembly, and said water conduit assembly are major components;
said major components being coupled to each other substantially without coupling hardware.

14. The hose reel of claim 12 wherein said water conduit assembly is coupled to said frame assembly by at least a movable clip assembly.

15. The hose reel of claim 14 wherein said water conduit assembly is coupled to said frame assembly by a movable clip assembly and a plurality of snap-fit couplings.

16. The hose reel of claim 12 wherein said at least one wheel is coupled to said frame assembly by a snap-fit coupling.

17. The hose reel of claim 12 wherein:
said frame assembly handle assembly includes a generally U-shaped handle assembly body with an elongated, first arm and an elongated second arm, each said arm having a distal end;
a first annular coupling disposed at said first arm distal end;
a second annular coupling disposed at said second arm distal end;
wherein said first and second annular couplings are structured to be rotatably coupled to said frame assembly and disposed about said axis of rotation;
said frame assembly having two hubs each with an opening, said hub openings being aligned, said frame assembly openings structured to rotatably support said basket assembly;
a rotational coupling disposed between said basket assembly and said frame assembly at each said hub, each said rotational coupling rotatably coupled to one frame assembly opening, said rotational coupling including a body having an inner cylindrical portion and an outer cylindrical portion;
each said rotational coupling inner cylindrical portion and outer cylindrical portion having a snap-fit coupling;
each said inner cylindrical portion snap-fit coupling structured to engage said barrel; and
each said outer cylindrical portion structured to pass through one of said first annular coupling or said second annular coupling, each said outer cylindrical portion snap-fit coupling structured to engage said frame assembly.

18. The hose reel of claim 17 wherein:
said outer cylindrical portion being hollow, said outer cylindrical portion inner surface has a non-circular cross-sectional shape, said outer cylindrical portion inner surface having at least one opening for a snap-fit coupling;
said frame assembly includes a basket crank having a grip, a crank arm, and a mounting lug; and
said mounting lug having a snap-fit coupling and a non-circular cross-sectional shape corresponding to the shape of said outer cylindrical portion inner surface, whereby said mounting lug is structured to be disposed in said outer cylindrical portion and thereby be fixed thereto.

19. The hose reel of claim 12 wherein:
said handle assembly includes at least one flexible extension forming an open sided pocket; and
said frame assembly includes an accessory tray having a body and at least one flexible extension shaped to correspond to, and fit snugly within, said handle assembly at least one flexible extension open sided pocket.

20. The hose reel of claim 12 wherein said water conduit assembly is made from aluminum.
